(19) United States
(12) Patent Application Publication
(10) Pub. No.: US 2021/0325679 A1
(43) Pub. Date: Oct. 21, 2021

(54) SYSTEM FOR AUGMENTING FISHING DATA AND METHOD

(71) Applicant: Robert Layne, Tampa, FL (US)

(72) Inventor: Robert Layne, Tampa, FL (US)

(21) Appl. No.: 17/269,412

(22) PCT Filed: Aug. 22, 2019
(86) PCT No.: PCT/US2019/047727

§ 371 Date: Feb. 18, 2021

Related U.S. Application Data
(60) Provisional application No. 62/721,146, filed on Aug. 22, 2018.

(51) Int. Cl. G02B 27/01

(52) U.S. Cl. CPC G02B 27/0172; G02B 2027/0138; G02B 2027/0178; G02B 2027/0141

(57) ABSTRACT

A system for augmented reality for fisherman comprises inputs and a head mounted display for displaying information from inputs relating to fishing data from a plurality of sources, such as video, sensors, navigational aids and transducers.

### CROSS RELATED APPLICATIONS

This application is a 371 U.S. national phase application which claims priority to PCT/US2019/047727 filed Aug. 22, 2019 which claims priority to U.S. Provisional Appl. No. 62/721,146, filed Aug. 22, 2018, which is incorporated herein by reference in its entirety.

### FIELD OF THE INVENTION

The field relates to the collection and presentation of information relevant to fishermen and display technology.

### BACKGROUND

European patent publication 3,064,958 A1 discloses a sonar system and transducer assembly for 3D images of an underwater environment. U.S. Pat. Puhl. 2008/0101159 discloses a personal sonar system with noise filter that warns of hazards. U.S. Pat. Nos. 8,964,298 and 8,195,395 discloses a near field communication device that uses wireless communications for a wrist and eyepiece device, and a floating buoy system that includes a communications system for providing information about waves and navigation. U.S. Pat. Puhl. 2013/0278631 discloses a head mounted display, which provides a label and determines a distance to objects viewed by the wearer. U.S. application Ser. No. 11/104,379, filed Apr. 11, 2005, discloses a 3-D virtual reality and/or augmented reality system based on a plurality of inputs, which is incorporated by reference herein in its entirety.

### SUMMARY

A multi-modal system augments sources of data relevant to fishing and presents the data to a fisherman. For example, a system comprises a display, an input device, a processor and a data source comprising data relevant to fishing coupled electronically to the processor, input device and display such that data generated by the data source is presented on the display augmenting the vision of a person using the system. For example, the display may comprise eye wear or a heads up display. Eye wear may comprise glasses having an organic light, emitting diode screen or a projected image using a reflective display and/or a planar illumination facility comprising transfer optics, such as a waveguide, a light source, such as a light emitting diode light source, a laser light source, or the like, and the reflective display coupled to the light source by the transfer optics. For example, the display may be a reflective liquid crystal display, a liquid crystal display on silicon, a cholesteric liquid crystal, guest-host liquid crystal, polymer dispersed liquid crystal, phase retardation liquid crystal and the like.

In one example, the glasses present augmented vision. Augmented vision means that data and images are visible to a fisherman looking through a windscreen, eyewear lens or lenses of glasses. For example, the input device allows a fisherman to select a location and a destination. Then, the glasses may provide navigational directions to the wearer that include warnings of known navigational hazards, tidal information, navigable channel information and navigation directions, for example. For example, the system may include or be coupled electronically with a global positioning system device capable of determining the location of the glasses. In one example, the system is coupled with navigational buoys and may determine position, wave, tidal and weather conditions based on information received from the buoys. For example, the display may show a course or course corrections that may change depending on the orientation of the wearer.

In one example, the system is coupled with a sonar device, and the system may provide the user with images generated from the sonar device, showing, for example, contours of the sea bed or lake bed, objects and the location of fish. In one example, an image on the display of eye wear allows the wearer to see through the hull of a boat or ship at the subterrain and objects under the water surface.

In one example, a system for augmenting fishing data comprises a communications system for receiving data from a plurality of sources, wherein the plurality of sources comprise wireless sensors, wirelessly transmitted image data, and navigational data from third party instruments; an augmented reality display device for displaying the data from the plurality of sources such that the data becomes useful, real-time information for a user of the system; and a control apparatus that provides user input for controlling the augmented reality display device.

For example, the augmented reality display device may be incorporated into eye wear or a heads up display. The eye wear may comprise glasses having an organic light emitting diode screen, a projected image using a reflective display, or a planar illumination facility comprising transfer optics. The transfer optics may comprise a waveguide or a light source, for example. A light source may comprise a laser light source, for example. The augmented reality display device may comprise a reflective liquid crystal display, a liquid crystal display on silicon, a cholesteric liquid crystal display, a guest-host liquid crystal display, a polymer dispersed liquid crystal display, or a phase retardation liquid crystal display, for example.

In one example, an augmented reality display device makes superimposed images related to the data from the plurality of sources visible to a user looking through the augmented reality display device without blocking the user's vision. A control apparatus may provide for input of a selected destination, for example, and the system may determine the location of the user and navigational directions for a boat to take from the location of the user to the selected destination, automatically. The system may display navigational directions to the user comprising warnings of known navigational hazards, tidal information and/or navigable channel information. The system may display navigational directions optimized to avoid known navigational hazards. In one example, the plurality of sources comprises data about the draught of a user's boat. For example, the draught, a distance between the water line and the keel of the boat may be entered into the system by the user or may be provided by one or more sensors, automatically.

The plurality of sources may comprise global positioning data, navigational buoy data including position, wave and tidal data, and/or sonar data. The sonar data may be displayed as augmented reality images depending on an orientation of the augmented reality display device. For example, the augmented reality images may comprise contours of a sea or lake bottom, the location of hazardous objects or locations of fish or marine life, and may be three dimensional images visually appearing, as an optical illusion to a user, as if projected beyond a visually transparent hull of a boat. The plurality of sources may further comprise a weight sensor integrated into a scale for measuring the weight of a catch, a length detection system for determine the length of a catch and other data of special significance to fisherman.

### BRIEF DESCRIPTION OF THE DRAWINGS

The following drawings are illustrative examples and do not further limit any claims that may eventually issue.

FIG. 1 illustrates an example of a system for augmenting fishing data.

FIG. 2 illustrates an example of a light source for projecting an image using a reflective surface or a waveguide.

FIG. 3 illustrates a schematic exploded view of an example utilizing a reflective waveguide.

FIG. 4 illustrates an organic light emitting diode screen integrated into the lens of eyewear.

FIGS. 5A-B illustrate an example of an augmentation image as a navigational aid.

FIGS. 6A-B illustrate an example of an input device and/or control device for a system for augmenting fishing data.

FIG. 7 illustrates a schematic flow chart for navigational augmentation.

FIG. 8 illustrates a schematic flow chart for fish identification augmentation.

FIG. 9 schematically illustrates a method of calibration and fish size augmentation.

FIG. 10 schematically illustrates a weight scale for fish weight augmentation.

FIG. 11 illustrates a schematic flow chart for fish identification, length and weight augmentation.

FIG. 12 illustrates a sonar system capturing data for underwater visual augmentation.

FIG. 13 schematically illustrates a sensor adapter for capturing and transmitting augmentation data.

FIG. 14 illustrates a camera for capturing augmentation data.

FIG. 15 illustrates an infrared camera for capturing augmentation data.

When the same reference characters are used, these labels refer to similar parts in the examples illustrated in the drawings.

### DETAILED DESCRIPTION

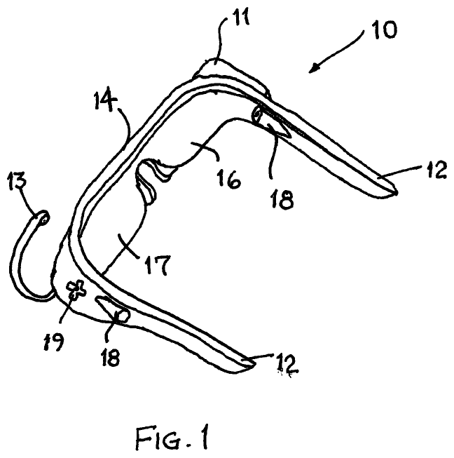

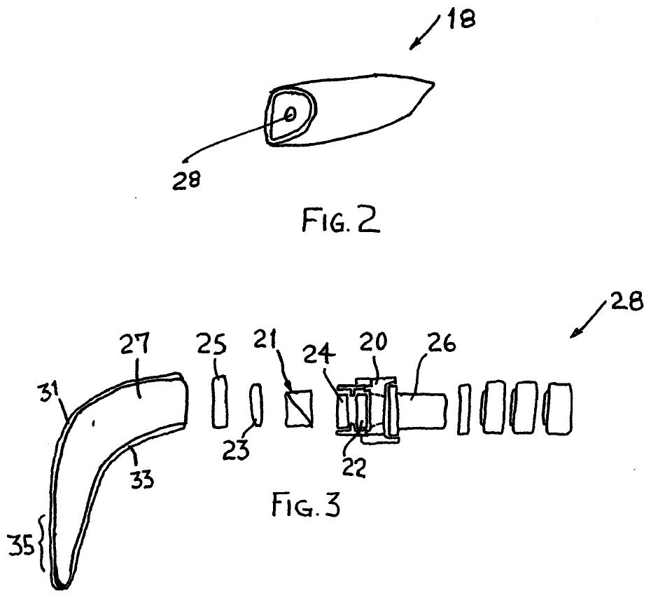

In one example, such as illustrated in FIG. 1, a system for augmenting fishing data comprises eyewear, such as glasses, wirelessly coupled electronically to a plurality of sources of data for augmenting fishing data visually. In addition to or alternatively to visual augmentation, a speaker or ear piece may be provided internally or externally to the eyewear 10. For example, the ear pieces 12 may incorporate a speech transmission device that transfers audible sounds. A light source 18, such as a laser or LED light source, may be integrated into the frame. For example, a light source 18 is disclosed in more detail in the drawings of FIGS. 2 and 3. Batteries are shown in the exploided view of FIG. 3; however, a capacitor or other energy source may be substituted for the batteries. An LED or laser projector 26 emits light and may be mounted to a heat sink or heat dispersion body and holder assembly. The light may be emitted through a tapered light tunnel 20 through a diffuser 22 and a lens 24, such as a condenser lens. The tunnel 20 may have a reflective coating for homogenizing the light emitted from the light source 18, for example. The diffuser 22 further homogenizes the light before passing through the lens 24. The light then passes through a beam splitter 21 which may split the light into polarized components before being refracted to another lens 23, such as a field lens, and transmitted to a image display screen 25, where an image is displayed, and the screen may be transmissive or reflective. If reflective, then the image returns to the beam splitter and is emitted at an angle and uses reflective surfaces to direct it to the waveguide 27. If transmissive, then the light enters the waveguide 27 directly through the display screen 25. In one example of the waveguide 27, the image is reflected from a first reflective surface 31 to a second reflective surface 33 and to a reflective screen 35, which reflects the image to the eye of a wearer, such that the image augments the vision of the wearer as seen through the optically transparent waveguide 27.

For example, such a system may be configured as disclosed in “Three dimensional virtual and augmented reality display system,” U.S. Pat. No. 8,950,867, which is incorporated in its entirety herein by reference. In one example, the image may be an augmented reality image showing the depths of a body of water on which a vessel is floating. For example, the image may be comprised of a three-dimensional reconstruction of a sonar images captured by a sonar device, such as the sonar device disclosed in “Linear and Circular Downscan Imaging Sonar,” U.S. Pat. No. 9,223,022, which is incorporated in its entirety herein by reference.

For example, the image displayed on the display screen 25 may be selected based on the orientation of the eyewear, which ultimately depends on the orientation of the head of the wearer. If the wearer looks at the bottom of the boat, a three dimensional reconstruction of the bottom of the depths below the boat may be displayed in augmented reality, making the bottom of the boat transparent or semi-transparent to the wearer. For example, hazards such as reefs, sand bars, wrecks and pilings may be displayed in a way that brings attention to such hazards for navigation around or through such hazards. Alternatively, the structure of the bottom may be of particular interest to fisherman, because certain types of fish may select certain types of structures for feeding, security and the like. In on example, data from sonar imaging may be captured and retained in a database from current or previous sonar mapping of bottom structures.

In one example, current and historical data may be matched with global positioning system data and saved in a database, and the images shown to the wearer may incorporate images from this stored and reconstructed information. For example, the image may show how a sand bar has moved over the course of time and/or recent damage to a reef or other bottom structures, for example. In one example, old imagery is displayed in a color, shade or gray scale different from new imagery to set apart old imagery from new sonar imagery. This may be particularly helpful to fisherman that rely on historical data about where the best fishing spots are found. It may be useful for purposes of navigation, also, if a new underwater hazard has appeared that was not known previously. This type of information may be of interest to conservationists, as well.

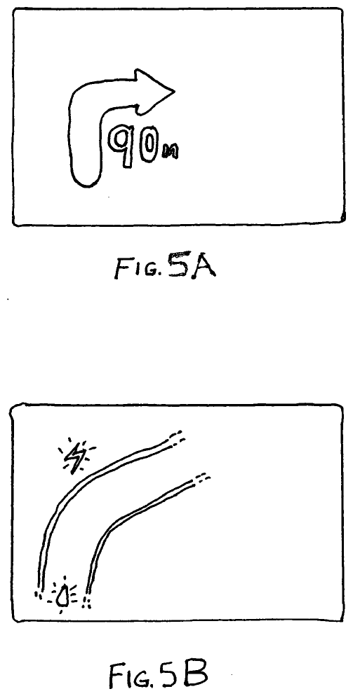

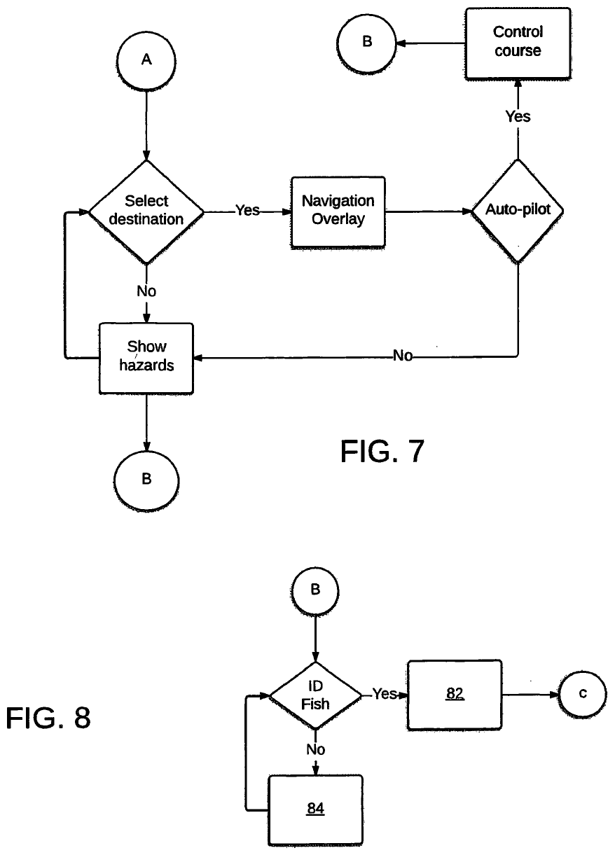

FIG. 7 illustrates a method of boat navigation, for example. The user may select a destination using an input device 60, for example. If no destination is selected, then the system will display known or detected hazards and may provide navigational directions for avoiding the hazard. If a destination is selected, then a navigational overlay, such as illustrated in FIGS. 5A and 5B may be provided. Alternatively, or in addition to the navigational overlay, the system may be coupled to an autopilot system, and may show known or detected hazards and provide a warning or navigational directions to the wearer or directly to the autopilot system. In this way, the system may provide course control, for example.

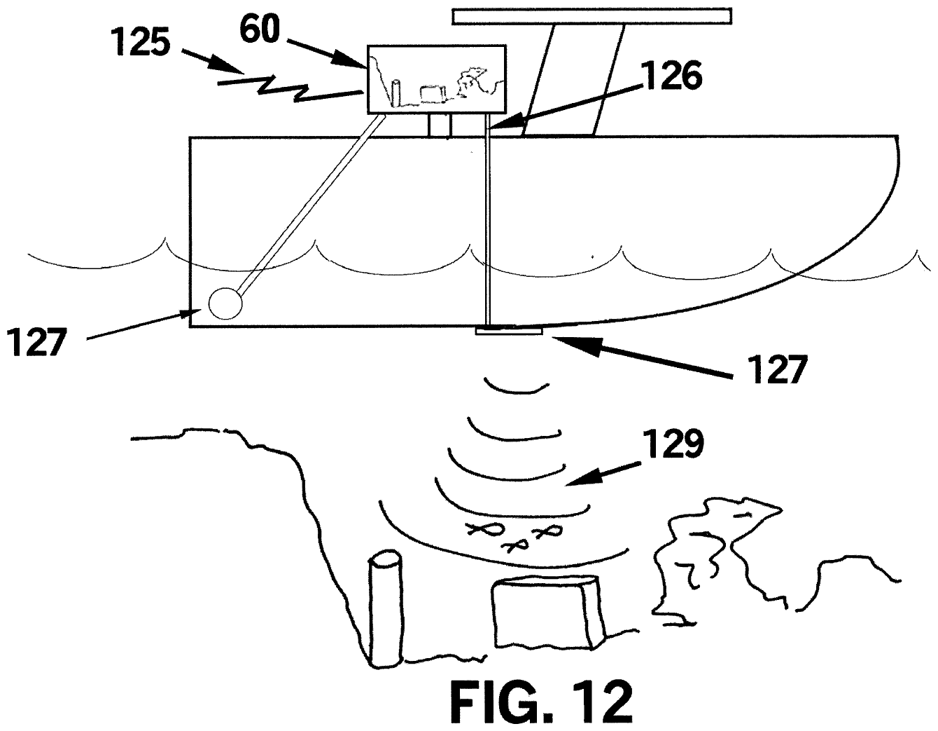

FIG. 12 illustrates, schematically, a sonar system that may be utilized as an input device 60 for the system. A touchscreen display is coupled by wireless communications 125 to the system and by wire 126 to one or more transducers 127 that emit and receive acoustic signals 129 that image bottom structure and fish, under and around a vessel, on the display 124.

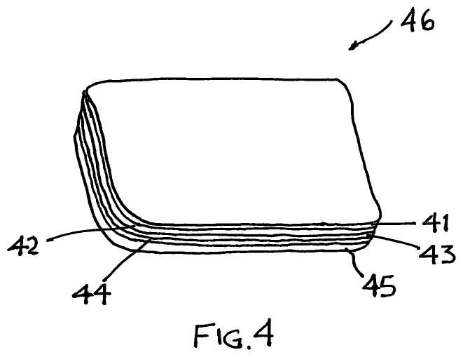

FIG. 4 illustrates an alternative way of displaying images to a wearer, utilizing an active lens 46, which projects its image to the eye of the wearer using a plurality of transmissive screens 42, 43. These display screens 42, 43 may be made using organic LED's to overlay images augmenting the vision of the wearer, for example. Each of the plurality of layers 42, 43 may be used to display different types of information or may be integrated to display a single image, for example. Additional layers 41, 44, 45 may be provided to protect the display screens 42, 43 from damage or to provide protection to the wearer. For example, a sun protection layer 45 may be provided that prevents damage to the display screens 42, 43 and the eyes of the wearer from bright sun. This sun protection layer 45 may be mechanically added to the eyewear by clipping or adhering the layer onto the eyewear such as a layer utiilizing the material described in “Semiconductor nanocrystal quantum dots and metallic nanocrystals as UV blockers and colorants for suncreens and/or sunless tanning compositions,” U.S. Pat. Publication 2005/0265935 A1, which is incorporated herein by reference in its entirety, or may be an active layer, such as the “Liquid crystal active light shield,” disclosed in U.S. Pat. No. 4,560,239, which is incorporated herein in its entirety. The wearer can see a 3-D view around the vessel from transducers 127, using 3-D virtual reality, such as disclosed in U.S. application Ser. No. 11/104,379, for example.

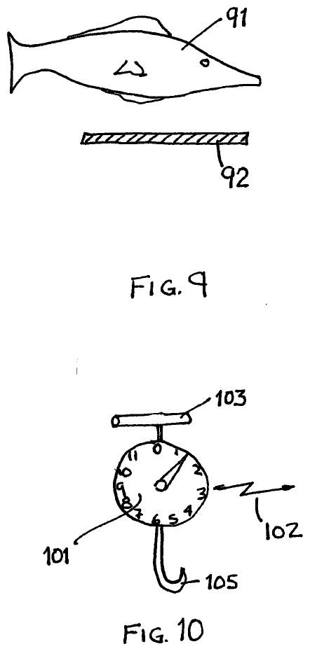

In one example, such as illustrated in FIG. 9, the system utilizes a high contrast marker 92 adhered to a deck for determining the length of a fish placed on the deck in proximity to the marker 92. The eyewear utilizes the known length of the marker to determine the overall length of the fish, regardless of the height of the wearer or the distance of the eyewear from the fish. The eyewear may utilize the information about length and information about the type of fish, from a camera integrated into the system, to determine if the fish is a keeper or must be released, for example. In one example, as illustrated in FIG. 10, a scale utilizes wireless communications 102, such as Bluetooth, WIFI or the like, and a gaffe, hook 105 or the like to send information about the weight of the fish to the system. Thus, the system may include the weight in determining whether or not to keep a particular fish.

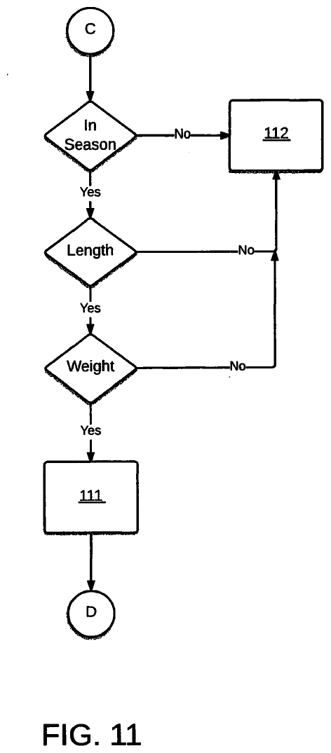

In one method, such as illustrated in FIGS. 8 and 11, the wearer selects a function to identify a fish that has been caught. For example, a camera takes one or more pictures or video of the fish on a deck. As illustrated in FIG. 8, the process compares the images of a fish with data in a look up table (LUT) and determines one or more matches to the images of the fish. If the system cannot identify the fish, the system may request input from the user to help in selecting the type of fish, which may utilize a selector 19 or a voice input device 13 of an external input device 60 for user input. If the system determines the type of fish or the user selects the type of fish, then the system may enter an algorithm to determine if the fish is in season by accessing a database. If the fish is not in season, then a message is provided to the fisherman that indicates the fish is to be released. If the type of fish is in season, then the length of the fish may be determined, such as illustrated in FIG. 9. If the fish is of a length that is allowed to be kept, or if length is not relevant, then the weight of the fish may be determined as illustrated in FIG. 10. If the weight of the fish is acceptable or is not relevant, then a message may be provided that the fish is a keeper, for example.

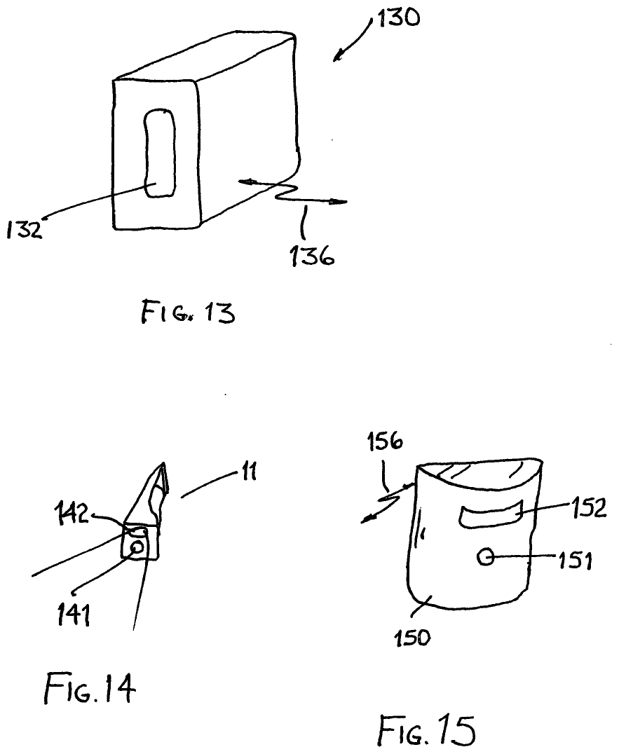

In one example, a minaturized camera 11 may be integrated or added to the eyewear. For example, FIG. 14 shows a camera 11 that may comprise a light source 142 and a lens 141, for example, that may direct images to a CCD within the camera 11. Alternatively or in addition to an optical camera, an external camera 150 may comprise image capture for a plurality of wavelengths, such as infrared, ultraviolet or the like. This external camera may comprise wireless communications 156 coupling the camera to the system.

Examples of navigational direction overlays are illustrated in FIGS. 5A and 5B. In FIG. 5A, a simple arrow and distance indicator may be used to direct the wearer. In FIG. 5B, a path is provided by port and starboard guardrails and a hazard is shown by a hazard marker, for example.

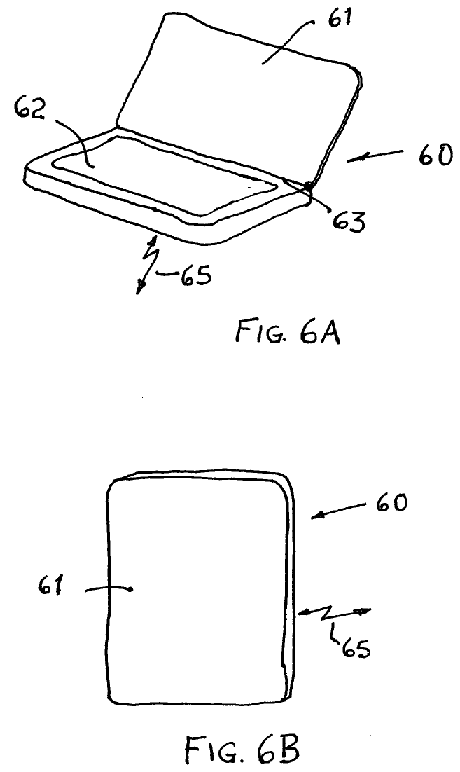

In FIGS. 6A and 6B, examples of input devices are shown. For example, a screen 61 may be integrated with a touchpad 62 by a hinge 63 in an input device 60, which may be coupled with the system by wireless communications 65. Alternatively, a computer tablet or pad may be utilized as the input device 60, which may utilize a touchscreen 61 for both display and input and may be coupled by wireless communications 65 to the system.

In one example, such as illustrated in FIG. 13, a wireless adapter 130 may use wireless communications 136 to provide information about external systems to the system. An adapter 132 may be utilized to attach the adapter to a wide variety of external data outputs.

This detailed description provides examples including features and elements of the claims for the purpose of enabling a person having ordinary skill in the art to make and use the inventions recited in the claims. However, these examples are not intended to limit the scope of the claims, directly. Instead, the examples provide features and elements of the claims that, having been disclosed in these descriptions, claims and drawings, may be altered and combined in ways that are known in the art.

1. A system for augmenting fishing data comprises:
a communications system for receiving data from a plurality of sources, wherein the plurality of sources comprise wireless sensors, wirelessly transmitted image data, and navigational data from third party instruments, and data about the draught of a boat is provided to the system;
an augmented reality display device for displaying the data from the plurality of sources such that the data becomes useful, real-time information for a user of the system; and
a control apparatus that provides user input for controlling the augmented reality display device, wherein the augmented reality display device is incorporated into eye wear.

2. (canceled)

3. The system of claim 1, wherein the the eye wear comprises glasses having an organic light emitting diode screen.

4. The system of claim 1, wherein the eye wear comprises a projected image using a reflective display.

5. The system of claim 1, wherein the eye wear comprises a planar illumination facility comprising transfer optics.

6. The system of claim 5, wherein the transfer optics comprise a waveguide or a light source.

7. The system of claim 6, wherein the transfer optics are a light source, and the light source is a laser light source.

8. The system of claim 1, wherein the augmented reality display device comprises a reflective liquid crystal display, a liquid crystal display on silicon, a cholesteric liquid crystal display, a guest-host liquid crystal display, a polymer dispersed liquid crystal display, or a phase retardation liquid crystal display.

9. The system of claim 1, wherein the augmented reality display device makes superimposed images related to the data from the plurality of sources visible to a user looking through the augmented reality display device without blocking the user's vision.

10. The system of claim 9, wherein the control apparatus provides for input of a selected destination.

11. The system of claim 10, wherein the system determines the location of the user and navigational directions for a boat to take from the location of the user to the selected destination.

12. The system of claim 11, wherein the system displays navigational directions to the user comprising warnings of known navigational hazards, tidal information or navigable channel information.

13. The system of claim 11, wherein the system displays navigational directions to the user comprising warnings of known navigational hazards, tidal information, navigable channel information and navigation directions.

14. The system of claim 12, wherein the navigation directions are optimized to avoid known navigational hazards.

15. (canceled)

16. The system of claim 1, wherein the draught is entered into the system by the user.

17. The system of claim 14, wherein the plurality of sources comprise global positioning data.

18. The system of claim 14, wherein the plurality of data sources comprise navigational buoy data including position, wave and tidal data.

19. The system of claim 14, wherein the plurality of sources comprise sonar data.

20. The system of claim 19, wherein the sonar data are displayed as augmented reality images depending on an orientation of the augmented reality display device.

21. The system of claim 20, wherein the augmented reality images comprise contours of a sea or lake bottom, the location of hazardous objects or locations of fish or marine life.

22. The system of claim 21, wherein the augmented reality images are three dimensional images visually appearing to a user to be projected beyond a visually transparent hull of a boat.

23. The system of claim 1, wherein the plurality of sources comprises a weight sensor integrated into a scale for measuring the weight of a catch.
